(19) United States
(12) Patent Application Publication
(10) Pub. No.: US 2012/0258234 A1
(43) Pub. Date: Oct. 11, 2012

(54) INCREASED DIETARY FIBER METHOD AND TREATMENT FOR PROCESSED FOODS

(76) Inventors: Ronald Penna, Los Angeles, CA (US); Michael Osborn, Los Angeles, CA (US); Thomas Bilyeu, Los Angeles, CA (US)

(21) Appl. No.: 13/083,542

(22) Filed: Apr. 9, 2011

(51) Int. Cl. A23L 1/308

(52) U.S. Cl. 426/648

(57) ABSTRACT

The present invention is comprised of an increased dietary fiber method and treatment for processed foods to add dietary fiber to processed foods, control water activity (aw) and increase the pliability of the high fiber ingredients during mixing, blending and forming operations. The method adds soluble fiber ingredients to the processed food mixtures to provide consumers with a high fiber source to meet recommended daily Adequate Intake of fiber. The method additionally reduces non-fiber carbohydrate sources and sugar alcohols providing other beneficial physiological effects and helps to control water activity by using liquid soluble fiber to bind water adding to the shelf life of the processed food products. The treatment increases the pliability of the ingredient mixtures to more thoroughly combine, mix and blend the ingredients. The treatment continues to provide increased pliability of the completed product mixture during a product forming process.

### BACKGROUND

The USDA states that dietary fiber and the macronutrients they contain have beneficial physiological effects in humans. USDA reports that data shows Median intakes of Dietary Fiber for young men and women are half of the Adequate Intake (AI) for Total Fiber in foods. Currently many processed foods use non-fiber carbohydrates sources in order to increase pliability in forming or shaping processes such as bar making techniques. The reduced fiber content deprives the consumer of an opportunity to increase their dietary intake of fiber.

### BRIEF DESCRIPTION OF THE DRAWINGS

FIG. 1 shows a block diagram of an overview of an increased dietary fiber method and treatment for processed foods of one embodiment of the present invention.

FIG. 2A shows a flow chart of an increased dietary fiber method and treatment for processed foods high fiber flavored sweetener mixture process of one embodiment of the present invention.

FIG. 2B shows a flow chart of an increased dietary fiber method and treatment for processed foods dry ingredients coating process of one embodiment of the present invention.

FIG. 2C shows a flow chart of an increased dietary fiber method and treatment for processed foods forming process of one embodiment of the present invention.

FIG. 3A shows for illustrative purposes only shows an example of the increased dietary fiber method and treatment for processed foods for processing nutrition/protein bars of one embodiment of the present invention.

FIG. 3B shows for illustrative purposes only shows an example of the increased dietary fiber method and treatment for processed foods nutrition/protein bars forming process of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of nutrition/protein bars are described for illustrative purposes and the underlying process can apply to any food components in an increased dietary fiber method and treatment for processed foods. In one embodiment of the present invention, the increased dietary fiber method and treatment for processed foods is used for the ingredients of nutrition/protein bars through the controlled treatment with natural additives that control the dietary fiber content. The increased dietary fiber method and treatment for processed foods is adjustable and the amounts and types of flavorings, additives and processes can be adjusted to result in an increased dietary fiber content of any processed food using the present invention. In one embodiment of the present invention, the preservation process is used for the ingredients of nutrition/protein bars through the controlled treatment with natural additives that control the water activity (aw). The preservation process is adjustable and the amounts of additives and processes can be adjusted to result in the extension of shelf life of any processed food using the present invention.

### Dietary Fiber:

According to the USDA Dietary Fiber consists of non-digestible carbohydrates and lignin that are intrinsic and intact in plants. The USDA says that daily Adequate Intake of fiber has beneficial physiological effects in humans such as improved laxation, reduced risk of coronary heart disease, assisted maintenance of normal blood glucose levels, reduces the risk of diabetes, weight maintenance and increased prevention of various types of cancer. There is strong link between the use of fiber and reduced risk of colon cancer as well as beneficial effect of calcium on osteoporosis.

The collected data indicates that the consumption of fiber is well below, approximately one-half of the Adequate Intake of fiber recommended for all sexes and Life Stage Group. The present invention is a food treatment process that increases the quantity of dietary fiber in processed foods. USDA data shows the deficit in total fiber daily intake is 12 to 20 grams per day. High fiber ingredients are less pliable and this characteristic makes forming and shaping of finished processed food products a major consideration in reducing the selection of fiber containing ingredients.

### Preservation of Food:

The preservation of food for storage is a part of the history of the human race. Drying foods and packing foods in sugars and salts are processes thousands of years old. Even prehistoric humans knew that untreated foods would spoil in a very short time. Modern humans discovered that the growth of bacteria, yeasts and fungi or molds were the cause of this spoilage and potential food poisoning. During more recent decades nutritional studies have shown that while preservation is the goal the processes and ingredients used may add unwanted higher levels of carbohydrates and lack addition of desirable dietary fiber. Preservation can be accomplished by reducing the water activity (aw), shown by the abbreviation (aw), in foods being processed for storage and packaging.

### Water Activity in Food:

The water activity (aw) of a food is not the same thing as its moisture content or water content. Water content is the total amount of water in a product. Water in food which is not bound to food molecules can support the growth of bacteria, yeasts and fungi or molds. The term water activity (aw) refers to this unbound water. The water activity (aw) represents the ratio of the water vapor pressure of the unbound water of the food to the water vapor pressure of pure water under the same conditions, such as temperature, and it is expressed as a fraction.

The water activity (aw) scale extends from 0 aw (bone dry) to 1.0 aw (pure water) while most foods have a water activity (aw) level in the range of 0.2 aw for very dry foods to 0.99 aw for moist fresh foods. Water activity (aw) can also be expressed as equilibrium relative humidity (ERH). When the water activity (aw) fraction is multiplied by 100 the result obtained is the equilibrium relative humidity (ERH). The equilibrium relative humidity (ERH) is that which the foodstuff would produce if enclosed with air in a sealed container at constant temperature. Thus a food with a water activity (aw) of 0.7 aw would produce an ERH of 70%. Water activity (aw) affects the shelf life, safety, texture, flavor, and smell of foods.

### Predicting Food Spoilage:

Water activity (aw) is a useful application in predicting the growth of bacteria, yeasts and moulds. For a food to have a useful shelf life without relying on refrigerated storage, controlling either its acidity level (pH) or the level of water activity (aw) or a suitable combination of the two may be used. This can effectively increase the product's stability and make it possible to predict its shelf life under known ambient storage conditions.

Food can be made safe to store by lowering the water activity (aw) to a point that will not allow bacteria, yeasts, fungi or molds and dangerous pathogens such as Clostridium botulinum and Staphylococcus aureus to grow in it. For example a food with a water activity (aw) below 0.6 aw will not support the growth of osmophilic yeasts. Clostridium botulinum, the most dangerous food poisoning bacterium, is unable to grow at an (aw) of 0.93 aw and below. Low acid foods (pH>4.5) with a water activity (aw) greater than 0.86 aw allow the risk of food poisoning.

### Soluble Fiber—Isomalto-Oligosaccharide (IMO):

The present invention includes the use of isomalto-oligosaccharide (IMO) which contains dietary fiber. IMO is a natural nutrient sweetener refined from the starch of the corn, rice and other grains. The sweetness of IMO is about 70% of sugar. It is produced into both powder and liquid. IMO is a non-digestible, low calorie health sweetener that supports the proliferation of the beneficial bacteria residing in the large intestine (colon), therefore acts as a prebiotic. IMO improves overall gastrointestinal and bowel functions in humans in addition to having low calories. A diet with IMO was also shown to reduce the abdominal fat tissue in mammals. The effect of IMO on blood glucose level was predicted and expected to be effective therapeutically for diabetes or pre-diabetes. According to the FDA it has been reported in clinical trials that IMO do not cause any GI upset when consumed up to 10-20 g/day. Generally, IMO has been reported to be safe up to 30 g/day per adult individual. IMO is a soluble fiber which binds water to food. The binding of water to food extends shelf life by effectively controlling the water activity (aw) as part of a preservative treatment.

### Soluble Fiber—Inulin:

The present invention can include the use of inulin which contains dietary fiber. Inulin is a soluble fiber and can be used to replace sugar, fat, and flour in the control of water activity (aw). The soluble fiber inulin binds water to food. The binding of water to food extends shelf life by effectively controlling the water activity (aw) as part of a preservative treatment. Inulin is generally recognized as safe by the U.S. Food and Drug Administration (FDA). Inulin is a group of naturally occurring polysaccharides; several simple sugars linked together, and are produced by many types of plants. Some natural plants that contain high concentrations of inulin include for example chicory root, dandelion, wild yam, Jerusalem artichokes, jicama, onion, garlic and agave.

Inulin belongs to a class of fibers known as fructans. Most plants that synthesize and store inulin do not store other materials such as starch which contain high levels of glucose sugars. The sweetness of inulin can range from 10% to 50% of the sweetness of a sucrose solution of the same concentration equaling 100%. Inulin comes in both a dry powder and as syrup.

Normal digestion does not break inulin down into a monosaccharide. Inulin resists digestion because of the bonds holding its sugar molecules together. Inulin has a minimal impact on blood sugar and does not raise triglycerides, making it generally considered suitable for diabetics and potentially helpful in managing blood sugar-related illnesses. Inulin also has other health benefits such as increasing calcium absorption and possibly magnesium absorption. Inulin passes through the stomach and duodenum undigested and is highly available to the gut bacterial flora.

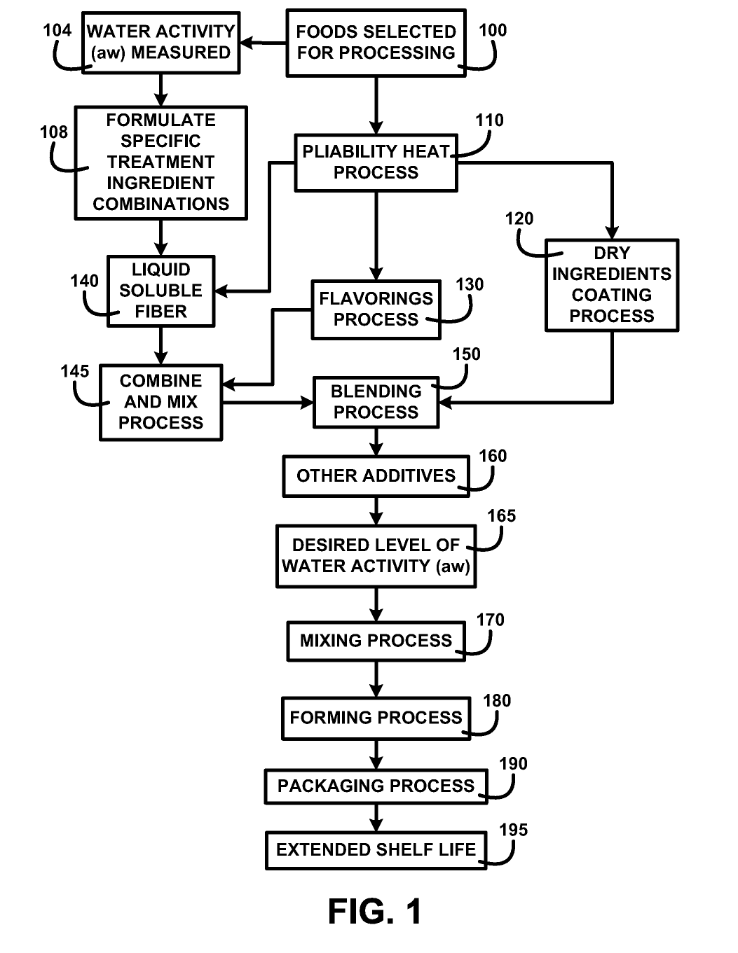

FIG. 1 shows a block diagram of an overview of an increased dietary fiber method and treatment for processed foods of one embodiment of the present invention. FIG. 1 shows foods selected for processing 100 that will go through processes to reduce carbohydrates as a preservative treatment and add dietary fiber. The foods selected for processing 100 have water activity (aw) measured 104 to formulate specific treatment ingredient combinations 108 to provide effective water activity (aw) control to extend shelf life. The specific proportions of the additive ingredients to be combined are formulated based on the water activity (aw) measured 104 ratio, taste and texture. The additive ingredients include liquid soluble fiber 140 that add dietary fiber, reduce carbohydrates and bind the water to the foods selected for processing 100 to control water activity (aw) as part of the preservative treatment. A pliability heat process 110 exposes the various high fiber ingredients to adjustable levels of heat to make the ingredients or combination of ingredients pliable.

A liquid soluble fiber 140 such as IMO is heated using the pliability heat process 110. The heated liquid soluble fiber 140 is added to a combine and mix process 145. A sweetener is heated using the pliability heat process 110 and mixed while at temperature with flavorings in a flavorings process 130. The heated flavorings-sweetener mixture is added to the combine and mix process 145. The combine and mix process 145 produces a high fiber flavorings-sweetener mixture of one embodiment of the present invention.

A dry ingredients coating process 120 uses the pliability heat process 110 to heat a binding agent such as fats that is used to coat dry ingredients. The coated dry ingredients and high fiber flavorings-sweetener mixture and combined in a blending process 150. The blending process is controlled being careful not to over mix, which will make the matrix clumpy and difficult to put through for example a slabber or extruder used to form the processed food. Other additives 160 are combined after the blending process to reach a desired level of water activity (aw) 165. The other additives 160 and blended ingredients are combined in a mixing process 170. The mixing process 170 is regulated to maintain the heat of the mixture of ingredients. The heated mixture of ingredients is pliable and easily worked in a forming process 180 of one embodiment of the present invention.

The forming process 180 can include passing the heated mixture through a slabber to roll sheets of the mixture which can be cut to the desired width and length. The heating of the mixture can be controlled to create pliability for processing the heated mixture through an extruder to for example create ropes of the mixture to cut immediately into desired lengths. The formed mixture is then ready for a packaging process 190. The packaging process 190 wraps individual product servings and these are packaged for example in boxes for distribution with an extended shelf life 195 created using the increased dietary fiber method and treatment for processed foods. The increased dietary fiber method and treatment for processed foods creates finished processed food products that have increased fiber content, reduced carbohydrates and extended shelf life 195 in a cost effective controlled process of one embodiment of the present invention.

### Detailed Operation:

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

### High Fiber Flavored Sweetener Mixture:

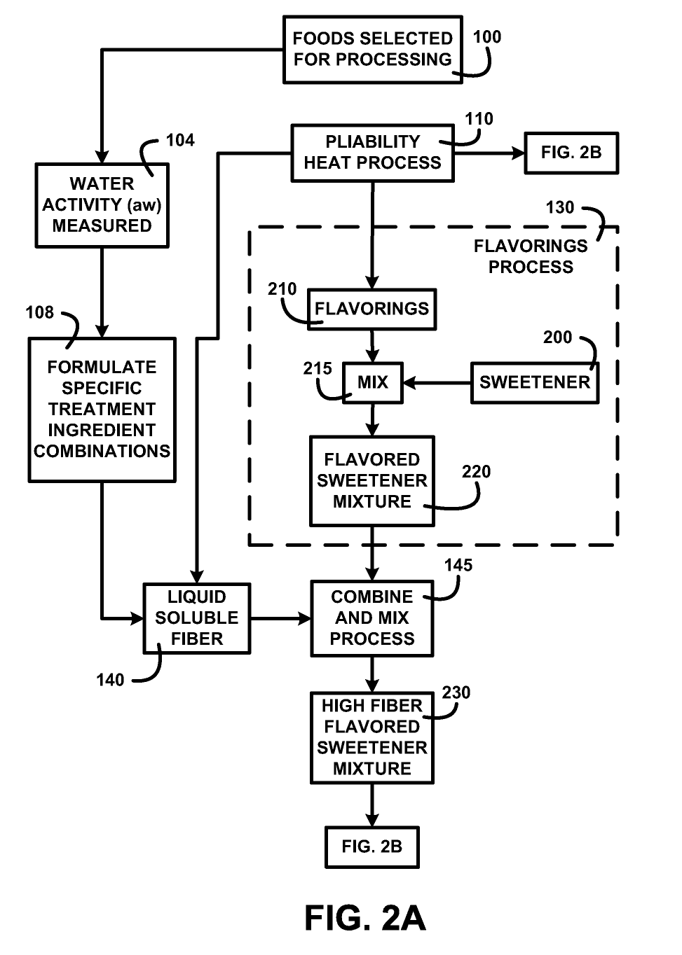

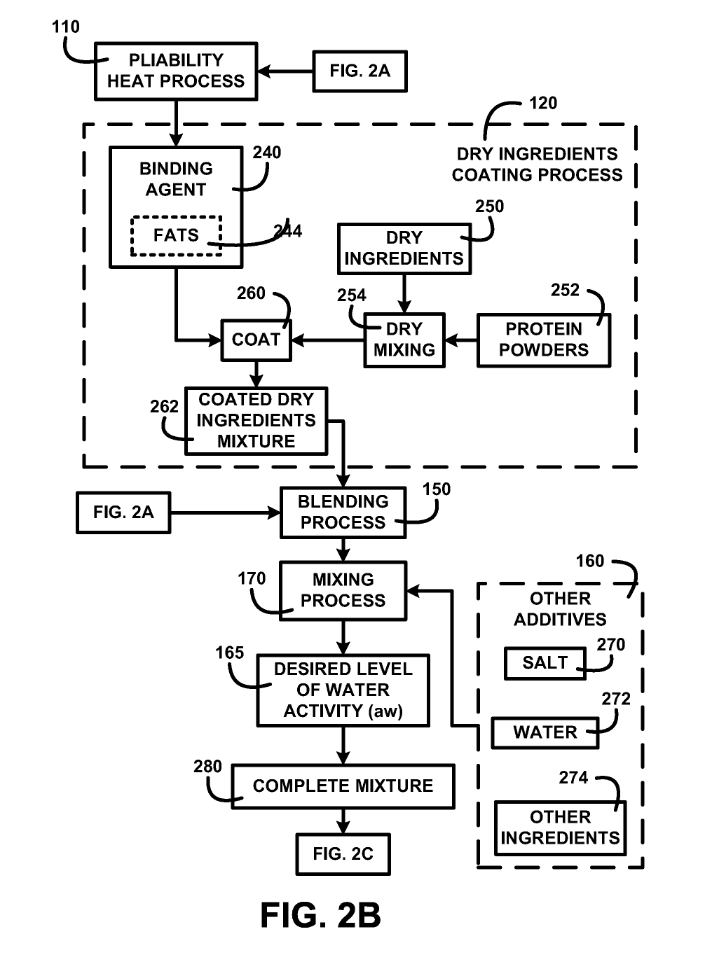

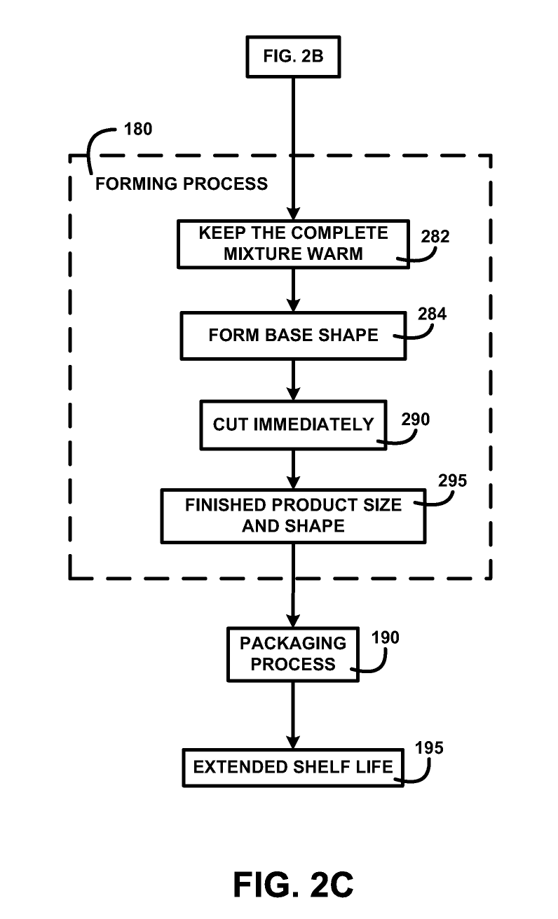

FIG. 2A shows a flow chart of an increased dietary fiber method and treatment for processed foods high fiber flavored sweetener mixture process of one embodiment of the present invention. FIG. 2A shows the foods selected for processing 100 that have the water activity (aw) measured 104. The particular foods selected for processing 100 can vary individually in water activity (aw) also in salt content and sweetness. Processed foods can be a single food or a combination of separate foods that have different characteristics such as texture, consistency, water content or levels of dryness, amounts of naturally occurring sugars, salts, and taste and water activity (aw) of one embodiment of the present invention.

The water activity (aw) measured 104 establishes a value of the level of water activity (aw) to be controlled. The desired characteristics of the finished processed food product are determined. The water activity (aw) measured 104 and finished processed food product values for characteristics such as taste and texture are evaluated to formulate specific treatment ingredient combinations 108. The specific proportions are formulated based on the measured water activity (aw) ratio, taste and texture. The preservative treatment ingredients include liquid soluble fiber 140 that add dietary fiber, reduce carbohydrates and bind the water to the foods selected for processing 100 to control water activity (aw) as part of the preservative treatment to extend shelf life of one embodiment of the present invention.

The pliability heat process 110 heats the liquid soluble fiber 140 ingredients. The flavorings process 130 begins with the heating of flavorings 210. The heated flavorings 210 and sweetener 200 ingredients are combined in a mix 215 process that mixes the ingredients to produce a flavored sweetener mixture 220. The heated flavored sweetener mixture 220 and liquid soluble fiber 140 ingredients pass through a combine and mix process 145 to create a high fiber flavored sweetener mixture 230. The high fiber flavored sweetener mixture 230 is further processed as shown in FIG. 2B of one embodiment of the present invention.

### Dry Ingredients Coating:

FIG. 2B shows a flow chart of an increased dietary fiber method and treatment for processed foods dry ingredients coating process of one embodiment of the present invention. FIG. 2B shows a continuation from FIG. 2A of the pliability heat process 110 as it is used in the dry ingredients coating process 120. Various dry ingredients 250 and for example protein powders 252 are combined in a dry mixing 254 process to allow a thorough combination of ingredients that are dry. The pliability heat process 110 is used to heat one or more binding agent 240 such as fats 244. The binding agent 240 is used to coat 260 the ingredients from the dry mixing 254 process. The high fiber flavored sweetener mixture 230 of FIG. 2A and coated dry ingredients mixture 262 are maintained at temperature by the pliability heat process 110 and combined in the blending process 150 of one embodiment of the present invention.

The blending process is controlled to provide a thorough mixing of the ingredient mixtures to prevent over mixing. Over mixing can make the combined mixtures clumpy and more difficult to form in the desired shapes. The other additives 160 such as salt 270, water 272 and other ingredients 274 are added to the heated blended ingredients. The proportions of the other additives 160 are measured to reach the desired finished processed food product characteristics including taste, texture and the desired level of water activity (aw) 165. The other additives 160 and the heated blended ingredients are combined in a mixing process 170. The mixing process 170 produces a complete mixture 280 of the selected ingredients that is further processed as shown in FIG. 2C of one embodiment of the present invention.

### Forming Process:

FIG. 2C shows a flow chart of an increased dietary fiber method and treatment for processed foods forming process of one embodiment of the present invention. FIG. 2C shows the continuation of the processes of FIG. 2B. The forming process 180 is performed immediately to keep the complete mixture warm 282. The warm complete mixture 280 of FIG. 2 is processed through forming equipment used to form base shape 284 of the finished processed food product. The form could be rolled sheets using a slabber or continuous ropes using an extruder. The base shaped warm complete mixture 280 of FIG. 2 is cut immediately 290 to a finished product size and shape 295. The finished product size and shape 295 processed food servings are cooled in process transit to the packaging process 190 of one embodiment of the present invention.

The final product is wrapped and boxed for distribution with an extended shelf life 195 created using the increased dietary fiber method and treatment for processed foods. The increased dietary fiber method and treatment for processed foods produces finished processed food products that contain higher fiber content, lower carbohydrates and extended shelf life 195 in a cost effective controlled process. The increased dietary fiber method and treatment for processed foods can be used to produce processed foods such as nutrition bars, candy bars, cookies, snack foods and other processed foods that contain high fiber to contribute to the USDA daily Adequate Intake of fiber recommendations of one embodiment of the present invention.

### High Fiber Nutrition/Protein Bars:

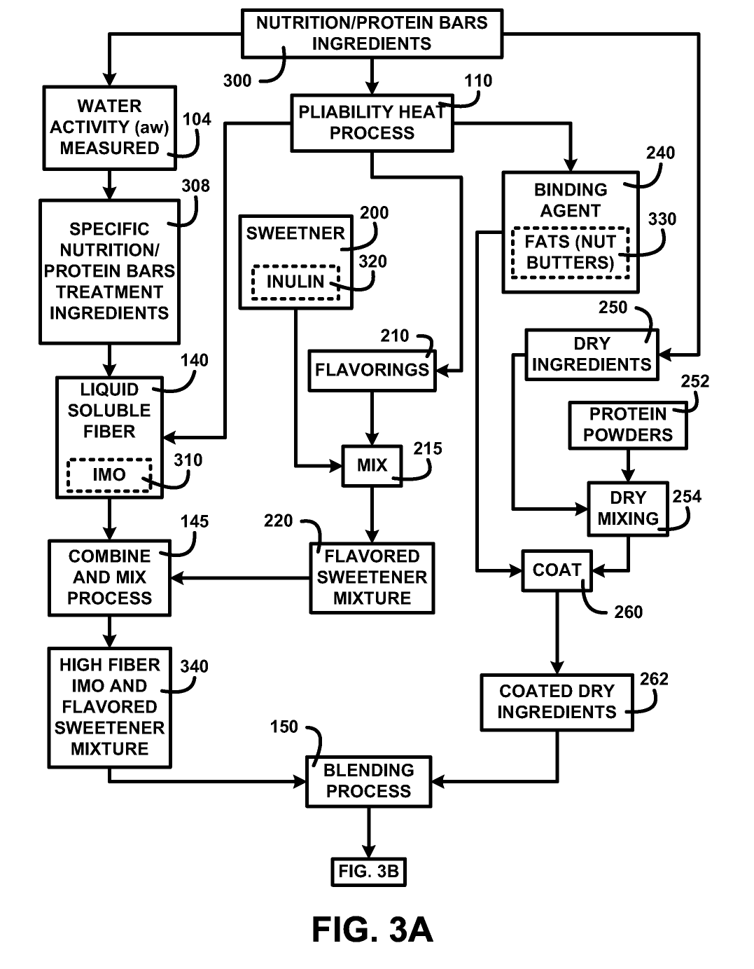

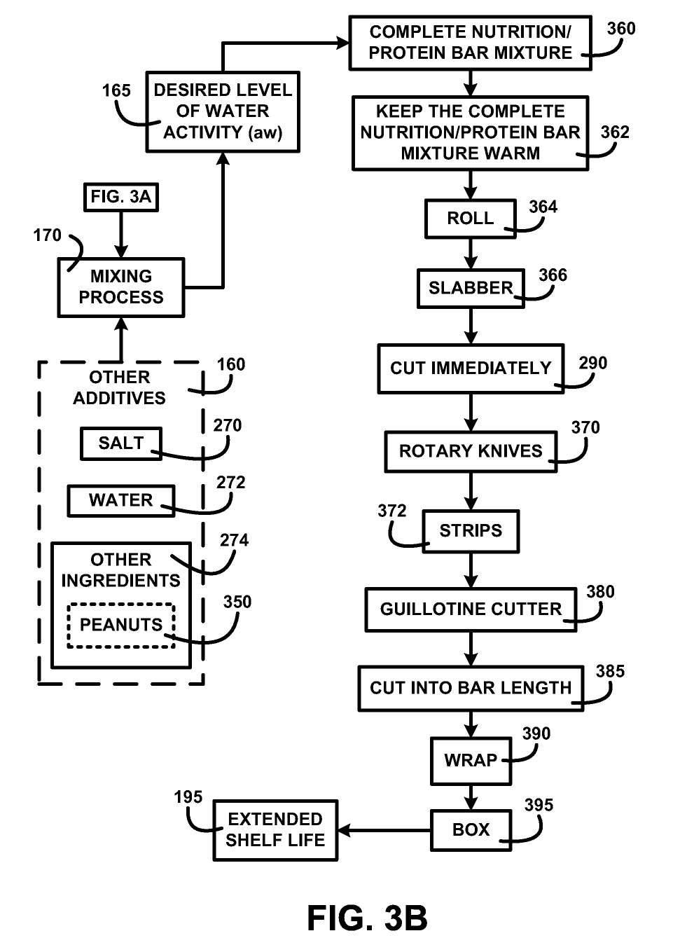

FIG. 3A shows for illustrative purposes only shows an example of the increased dietary fiber method and treatment for processed foods for processing nutrition/protein bars of one embodiment of the present invention. FIG. 3A shows an example of the increased dietary fiber method and treatment for processed foods used to produce a processed food product that contains high fiber. Various nutrition/protein bars ingredients 300 are selected. The nutrition/protein bars ingredients 300 can be selected for taste, flavor and texture to create a desired product. The nutrition/protein bars ingredients 300 selected have the water activity (aw) measured 104 of one embodiment of the present invention.

The water activity (aw) measured 104 and the desired nutrition/protein bar product characteristics of taste, flavor and texture are used to formulate specific nutrition/protein bars treatment ingredients 308. The specific nutrition/protein bars treatment ingredients 308 include liquid soluble fiber 140. The liquid soluble fiber 140 is added in either a liquid or powdered form mixed in solution. The liquid soluble fiber 140 includes dietary fiber ingredients such as IMO 310 and inulin 320 used to bind the water to control to control water activity (aw). The soluble fiber ingredients such as IMO 310 and inulin 320 are also used to add fiber in the increased dietary fiber method and treatment for processed foods will be used to contribute to the desired taste, flavor and texture of the finished product of one embodiment of the present invention.

The pliability heat process 110 heats the sweetener 200 in this example inulin 320 to a suitable temperature, such as 110 degrees. The heated sweetener 200 such as inulin 320 is combined in a mix 215 with the flavorings 210 to form the flavored sweetener mixture 220. The pliability heat process 110 continues heating the liquid soluble fiber 140 such as IMO 310 to a suitable temperature, such as 110 degrees, and the flavored sweetener mixture 220 in the combine and mix process 145. The combine and mix process 145 produces a high fiber IMO and flavored sweetener mixture 340 of one embodiment of the present invention.

The pliability heat process 110 applies heat to the binding agent 240 to reach a suitable temperature, such as 110 degrees, in this example fats (nut butters) 330. The dry ingredients 250 and the protein powders 252 selected for the nutrition/protein bars are combined in a thorough dry mixing 254. The heated fats (nut butters) 330 coat 260 the dry mixed ingredients creating a coated dry ingredients mixture 262 of one embodiment of the present invention.

The heated high fiber IMO and flavored sweetener mixture 340 and the heated coated dry ingredients mixture 262 are combined in the controlled blending process 150. The controlled blending process 150 prevents over mixing of the combination of ingredient mixtures. Over mixing can produce clumps which are difficult to form into the desired product shape. The process continues as shown in FIG. 3B of one embodiment of the present invention.

### Nutrition/Protein Bars Forming:

FIG. 3B shows for illustrative purposes only an example of the increased dietary fiber method and treatment for processed foods nutrition/protein bars forming process of one embodiment of the present invention. FIG. 3B shows the continuation of the processes in FIG. 3A. The other additives 160 are salt 270, water 272 and other ingredients 274 such as peanuts 350. The proportions of the other additives 160 are measured to reach the desired finished processed food product characteristics including taste, texture and the desired level of water activity (aw) 165. The heated blended mixtures from FIG. 3A are combined with the other additives 160 in the mixing process 170. The result of the mixing process is a complete nutrition/protein bar mixture 360 of one embodiment of the present invention.

The forming process 180 is performed immediately to keep the complete nutrition/protein bar mixture warm 362 to roll 364 sheets through a slabber 366. The rolled sheets from the slabber 366 are cut immediately 290 using rotary knives 370 to form strips 372. The strips 372 are passed through a guillotine cutter 380 and cut into bar length 385. The bar length sections cool during the process to the packaging process 190 of FIG. 1. The packaging process 190 of FIG. 1 continues to wrap 390 each bar length section into individual nutrition/protein bar servings which are placed into a box 395 for shipping. The increased dietary fiber method and treatment for processed foods controls the water activity (aw) which provides extended shelf life 195 to the finished nutrition/protein bars products. The nutrition/protein bars produced using the increased dietary fiber method and treatment for processed foods contains high fiber. In addition the liquid soluble fiber 140 ingredients used to add fiber also are non-digestible carbohydrates, provide heath benefits and are low in calories of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method for creating a food product containing water and food ingredients, comprising:
providing a treatment ingredient that includes liquid soluble fibers configured to bind the water and to control water activity in the food product;
heating the food ingredients to increase pliability before mixing with other ingredients;
coating dry ingredients with heated binding agents to create a coated dry ingredients mixture;
mixing heated flavorings with sweetener ingredients to produce a flavored sweetener mixture;
heating soluble fiber ingredients in a liquid form to add additional fiber to the mixtures; and
combining and mixing the flavored sweetener mixture and the heated soluble fiber ingredients to create a high fiber flavored sweetener mixture.

2. The method of claim 2, further comprising, blending the heated high fiber flavored sweetener mixture and coated dry ingredients mixture in a controlled process that prevents over mixing to prevent clumping, mixing other additives to the blended heated mixtures, keeping the mixed ingredients warm during forming and forming the warm mixed ingredients into a base product shape.

3. The method of claim 2, further comprising, cutting and forming the warm mixed ingredients base product shapes into finished product servings shapes, cooling the finished product servings during process transit to a packaging process and packaging the finished product servings for distribution.

4. The method of claim 1, wherein the soluble fiber ingredients includes Isomalto-oligosaccharide (IMO) configured to add dietary fiber and a taste sweetness modifier that contains non-digestible carbohydrates, wherein the IMO does not add significant dietary non-fiber carbohydrates, glucose, fructose, sugar alcohols and calories to the food product.

5. The method of claim 1, wherein the sweetener ingredients includes soluble fiber sweetener inulin for adding dietary fiber, wherein the inulin acts as a taste sweetness modifier that is a non-digestible carbohydrate, wherein the inulin does not add significant dietary non-fiber carbohydrates, glucose, fructose, sugar alcohols and calories to the food product.

6. The method of claim 1, wherein the binding agent includes at least one of fats and nut butters that contain soluble fiber that act as a taste sweetness modifier that does not add significant dietary non-fiber carbohydrates, glucose, fructose, sugar alcohols and calories to the food product.

7. The method of claim 1, wherein the ingredients heating is maintained to keep the ingredient mixtures warm during the mixing and blending processes to increase pliability during the processes.

8. The method of claim 1, wherein the other additives include at least one of salt, water and other food ingredients that act as a taste modifier and to control water activity.

9. A method for treating high fiber processed foods to increase ingredient and mixture pliability for mixing, blending and forming, comprising:
heating liquid soluble fiber, flavorings and binding agents ingredients before mixing to allow for thoroughly combining with other ingredients;
maintaining the heated temperature of the combined ingredients during progressive mixture formulation;
keeping the complete mixture of the ingredients warm to increase pliability during forming of the complete mixture into the product base shapes;
cutting and forming immediately the warm formed complete mixture into the desired finished product size and shape; and;
reducing the temperature of the finished product before a packaging process.

10. The method of claim 9, wherein the liquid soluble fiber, flavorings and binding agents ingredients are heated to a predetermined temperature that is adjusted to reach a desired level of pliability consistent with the nature of the other ingredient to be combined.

11. The method of claim 9, wherein the formed complete mixture is kept warm during the immediate cutting and forming to continue a desired level of pliability consistent to produce the desired finished product size and shape.

12. The method of claim 9, further comprising controlling the water activity (aw) using soluble fibers to bind the water and control water activity (aw) and reducing the temperature of the finished product to a desired level before a packaging process to control water activity and prevent sweating after being wrapped.

13. A method for adding fiber to nutrition/protein bar food products to increase dietary fiber content, comprising:
formulating specific nutrition and protein bar treatment ingredient combinations that include liquid soluble fibers to bind the water and to control water activity (aw);
heating flavorings to control pliability for mixing with sweetener ingredients;
mixing the heated flavorings and the sweetener ingredients to produce a flavored sweetener mixture;
heating liquid soluble fiber ingredients to control pliability;
combining and mixing the heated flavored sweetener mixture and the heated liquid soluble fiber ingredients to produce a high fiber sweetener mixture;
heating binding agents to coat dry ingredients;
dry mixing dry ingredients and protein powders to thoroughly mix the ingredients before coating;
coating the mixed dry ingredients with the heated binding agents to create a coated dry ingredients mixture;
blending the heated coated dry ingredients mixture with the heated high fiber IMO sweetener mixture in a controlled process to avoid over mixing to prevent clumping;
combining additives food ingredients into the blended heated coated dry ingredients mixture with the heated high fiber sweetener mixture to produce the complete nutrition/protein bar mixture;
keeping the mixture warm to roll the heated mixture through a forming device;
cutting or forming immediately the warm rolled mixture into strips;
cutting the warm mixture strips into the desired bar length; and
cooling the finished bar length servings during process transit to a packaging process.

14. The method of claim 13, wherein the heating process raises and maintains the temperature of the ingredients to a predetermined temperature to increase pliability of the ingredients and mixtures until the complete nutrition/protein bar mixture is formed and cut to the desired size and shape.

15. The method of claim 13, wherein the soluble fiber ingredients in a liquid form includes Isomalto-oligosaccharide (IMO) to bind the water and control water activity (aw) to extend shelf life and to add dietary fiber as a taste sweetness modifier that contains non-digestible carbohydrates that do not add significant non-fiber carbohydrates, glucose, fructose, sugar alcohols or calories to the processed nutrition/protein bar product.

16. The method of claim 13, wherein the sweetener ingredients include soluble fiber sweetener inulin to bind the water and control water activity (aw) to extend shelf life and to add dietary fiber as a taste sweetness modifier that are non-digestible carbohydrates that does not add significant non-fiber carbohydrates, glucose, fructose, sugar alcohols or calories to the processed nutrition/protein bar product.

17. The method of claim 13, wherein the binding agent includes fats and nut butters that contains soluble fiber to act as a taste sweetness modifier that does not add significant non-fiber carbohydrates, glucose, fructose, sugar alcohols or calories to the processed nutrition/protein bar product.

18. The method of claim 13, wherein the dry ingredients include protein powders to add protein to the nutrition/protein bar product.

19. The method of claim 13, wherein the other additives include salt, nuts, rolled oats, dried fruits as taste modifiers and to control water activity.

20. The method of claim 13, wherein the nutrition/protein bar product contains soluble fibers to bind the water and control water activity (aw) to extend shelf life and to create a high fiber content.
